(19) United States
(12) Patent Application Publication
(10) Pub. No.: US 2008/0253428 A1
(43) Pub. Date: Oct. 16, 2008

(54) STRAIN AND HYDROGEN TOLERANT OPTICAL DISTRIBUTED TEMPERATURE SENSOR SYSTEM AND METHOD

(75) Inventors: Trevor Wayne MacDougall, Simsbury, CT (US); Paul Eric Sanders, Madison, CT (US)

Correspondence Address: MCCORMICK, PAULDING & HUBER LLP, CITY PLACE II, 185 ASYLUM STREET, HARTFORD, CT, 06103, US

(73) Assignee: QOREX LLC, Hartford, CT (US)

(21) Appl. No.: 12/099,346

(22) Filed: Apr. 8, 2008

Related U.S. Application Data
(60) Provisional application No. 60/911,015, filed on Apr. 10, 2007.

(51) Int. Cl. G01K 3/00; G02B 6/00

(52) U.S. Cl. 374/137; 385/13

(57) ABSTRACT

A distributed temperature sensing system and method includes an optical sensing waveguide. The optical sensing waveguide is a single mode waveguide having a substantially pure silica core and a large outer diameter. The system further includes an optical instrument optically connected to the optical sensing waveguide. The optical instrument is configured for generating an optical excitation signal along the optical sensing waveguide, and is also configured for receiving a return optical signal indicative of the temperature at one or more locations along the optical sensing waveguide.

### CROSS-REFERENCE TO RELATED APPLICATION

This application claims the benefit of U.S. Provisional Application No. 60/911,015, filed on Apr. 10, 2007 and entitled “Strain And Hydrogen Tolerant Optical Distributed Temperature Sensor”, the disclosure of which is hereby incorporated by reference in its entirety.

### FIELD OF THE INVENTION

The present disclosure relates to distributed temperature sensing, and more particularly relates to strain and hydrogen tolerant optical distributed temperature sensor system and method.

### BACKGROUND OF THE INVENTION

Optical distributed temperature sensors, commonly referred to as “DTS” systems, based on fiber optic sensing techniques are being used broadly in a number of applications and markets (for more information, see www.sensa.org). Oil and gas applications for optical DTS have been especially prolific, being adopted by most downstream operators to monitor producing zones and take actions to optimize production. Optical DTS serving these oil and gas applications is predominantly based on nonlinear type optical sensors, in which high intensity pulsed laser energy is launched into a sensing fiber to stimulate nonlinear effects that cause light scattering. Optical DTS systems have been made using optical Raman effects and other optical DTS systems have been made using optical Brillouin effects. It is known that both Raman effects and Brillouin effects cause both forward (Stokes) and backward (anti-Stokes) shifted signals in which their relative intensity and/or frequency is dependent on temperature. Raman effects and Brillouin effects are discussed in the paper, Daniele Inaudi and Branko Glisic, “Integration of distributed strain and temperature sensors in composite coiled tubing”, 2006 SPIE Smart Structures and Materials Conference, San Diego, Calif., Feb. 27 to Mar. 2, 2006, (Authors from SMARTEC SA, Via Pobiette 11, CH-6928 Manno, Switzerland, www.smartec.ch), which is incorporated herein by reference in its entirety. Using Optical Time Delay Reflectometry (OTDR), temperature at distinct positions all along the fiber can be derived, so that the entire fiber is probed as a fully distributed temperature sensor.

Use of Raman type far exceeds that of the Brillouin type in current DTS systems primarily because of the advantage of Raman effect being insensitive to strain compared to the Brillouin effect (acoustic) that is sensitive to both temperature and strain. Use of the latter for DTS therefore requires complete isolation of fiber strain or extraction of its strain error in the temperature measurement. Conversely, Brillouin systems are frequently used to monitor strain in known or controlled thermal environments.

The main drawback to Raman systems in oil and gas applications is its sensitivity to hydrogen. Raman shifted lines are widely separated in wavelength (e.g. over 200 nm for a 1550 nm operating system), so received intensity of these lines, and subsequent temperature measurement, can be significantly offset by changes in background fiber attenuation because of hydrogen—which is pervasive in typical oil and gas well environments. Hydrogen diffusion into optical fibers results into both transient and permanent attenuation i.e., signal loss. Transient losses are reversible, caused by absorption owing to dissolved hydrogen in the glass. Upon removal of the fiber from the hydrogen environment, and subsequent out-diffusion of the hydrogen, the fiber returns to its original clarity. In contrast, permanent losses are irreversible, caused by chemical reactions of hydrogen with glass molecular defects that form light absorbing species (e.g. hydroxyl ion).

Upon hydrogen diffusion into the fiber, the magnitude of transient hydrogen loss is a function of hydrogen solubility, determined by the temperature and concentration of hydrogen the fiber is exposed to, with subsequent loss growth at several hydrogen absorption lines within the near-infrared telecom wavelength range of interest. Transient losses are essentially the same for silica fibers regardless of type-single mode or multimode, as solubility of hydrogen in the fiber is independent of these design features. In contrast, the chemical reactions that drive permanent losses are more complex: a function of defect type, their population, and the activation energy specific to each reaction. The range of potential defect types is dependent upon the glass composition, and their concentration created in subtleties of the fiber manufacturing process. As a consequence, contrary to transient loss, permanent losses manifest differently for different fibers, resulting in a more complex attenuation spectrum as each reaction product has its own absorption spectra. The sensitivity of fiber to permanent hydrogen loss is directly dependent upon the amount of common refractive-index modifying dopants used in conventional telecom-grade fibers such as germanium, boron, and phosphorus the latter two having been found to especially sensitize the fiber to hydrogen. Table 1 below lists the three common fiber types used in oil and gas sensing, and their relative hydrogen sensitivity.

TABLE 1

| | Core/Clad | Transient | Permanent |
|---|---|---|---|
| Fiber Type | Composition | Response | Response |
| Graded-Index | Si—Ge—P/Si | Same | Highly Sensitive |
| Multimode | | | |
| Single Mode (SMF-28) | Si—Ge/Si | | Sensitive |
| Pure Silica SM | Si/Si—F | | Low Sensitivity |

Intuitively, as can be seen in Table 1, pure silica core fiber that has no dopants in the core, exhibits superior hydrogen performance. Such pure silica single mode fibers were originally developed and have long been used in undersea telecommunication cables specifically for their insensitivity to permanent hydrogen losses. Pure silica core fibers are used in some downhole oil and gas cables to exploit this performance. Despite this advantage, most commercial Raman DTS systems are designed to operate on over multimode fibers because their larger core size creates more Raman scattering signal and allows for greater efficiency in capturing this light. However operating on these fibers makes these systems especially prone to hydrogen-induced measurement error associated with changes in background fiber attenuation.

Brillouin systems, on the other hand, are inherently less sensitive to such hydrogen errors. Brillouin systems operate exclusively on single mode optical fibers that are less sensitive to hydrogen-induced attenuation, and the separation between Brillouin lines is comparatively much smaller than with Raman lines—only fractions of nanometers—so that changes in background fiber attenuation tends to apply almost equally on the two lines. More importantly, however, relative to hydrogen effects, Brillouin systems measure frequency changes in these lines rather than intensity—the frequency shift independent and therefore not affected by changes in background fiber attenuation.

The below Table 2 illustrates some of the differences between Raman and Brillouin sensing systems.

TABLE 2

| Nonlinear DTS Type | Raman | Brillouin |
|---|---|---|
| Temperature Sensitivity | Yes | Yes |
| Strain Sensitivity | No | Yes |
| Stokes/anti-Stokes Separation From Incident | 100 nm | 0.01 nm |
| Light | | |
| Relative Stokes/anti-Stokes Peak Intensity | Weak | Strong |
| Hydrogen Sensitivity | High | Low |

Despite the superior hydrogen performance of Brillouin systems, faced with the tradeoff of strain and hydrogen sensitivity between the two nonlinear DTS technologies, Raman has emerged as the predominant technology in oil and gas because of its independence from strain effects. The Brillouin type is used much less due to the difficulty in isolating strain acting on downhole optical fiber cables. The sensitivity to hydrogen with Raman systems has been addressed by employing hydrogen barriers (cables and fiber coatings) to protect sensing fibers from hydrogen. While these hydrogen strategies have worked well, their effectiveness dissipates at higher temperatures, 200° C. or so, where they lose hermeticity (i.e., the hermetic seal with the outside), and become porous to hydrogen diffusion into the glass optical fiber.

While some oil and gas wells can be addressed at this temperature, there are emerging thermal recovery operations, especially in the unconventional heavy oil sector, that use steam flood operations in the production process. In many of these steam operations, for example Steam-Assisted Gravity Drainage (SAGD), there is great benefit in monitoring the steam front and/or thermal chamber growth to optimize steam injection and reservoir fluid inflow and recovery. A fully distributed optical DTS architecture along the injection and producing interval in SAGD, for example, is an ideal monitoring solution. However at the high operating temperature of these thermal recovery operations, in excess of about 250° C., hermetic barriers are ineffective, leading to significant hydrogen-induced degradation of quality of data in time, and shortened mean time to failure (MTTF). Commercial Raman DTS systems used successfully in the conventional market have exhibited poor performance in these thermal recovery applications with significant hydrogen-induced measurement offset (10 s of degrees Celsius) to render the data meaningless and total system failure because of hydrogen darkening of the fiber within a few weeks.

Because of the poor history of performance in high temperature thermal recovery operations, most operators will only use optical DTS during initial steam startup, or as a retrievable well survey tool. There are no effective hermetic solutions to the higher temperature operating regime above about 200° C. There remains no suitable optical DTS solution that delivers reliable data for reasonable period of time at the higher operating temperature of thermal recovery applications in oil and gas. Operators continue to use conventional thermocouples to monitor key points, with the size, complexity, and cost of these thermocouples limiting their use to only several points at most per well, which does not provide the desired number of sensing points and spatial resolution to give a meaningful representation of the well.

The following references contain subject matter related to as background to that discussed herein and the disclosure of each is hereby incorporated by reference in its entirety:
U.S. Pat. No. 4,767,219, entitled “Light scattering temperature measurement”, issued Aug. 30, 1988, to Bibby;
U.S. Pat. No. 6,853,798, entitled “Downhole geothermal well sensors comprising a hydrogen-resistant optical fiber”, issued Feb. 8, 2005, to Weiss;
Daniele Inaudi and Branko Glisic, “Integration of distributed strain and temperature sensors in composite coiled tubing”, 2006 SPIE Smart Structures and Materials Conference, San Diego, Calif., Feb. 27 to Mar. 2, 2006;
S. Grosswig, A. Graupner, E. Hurtig, K. Kühn, A. Trostel, “Distributed fiber optical temperature sensing technique—a variable tool for monitoring applications”, Proceedings of the 8th International Symposium on Temperature and Thermal Measurements in Industry and Science, June 2001, pp. 9-17, (2001);
J. P. Dakin, D. J. Pratt, G. W. Bibby, J. N. Ross, “Distributed optical fiber Raman temperature sensor using a semiconductor light source and detectors”, Electronics Lett., 21, pp. 569-570. (1998);
T. Horiguch, T. Kurashima, M. Tateda, “Distributed-temperature sensing using stimulated Brillouin scattering in optical silica fibers”, Opt. Lett., 15, No. 8, pp. 1038-1040, (1990); M. Niklès, L. Thévenaz, Ph. Robert, “Simple distributed fiber sensor based on Brillouin gain spectrum a analysis”, Optics Lett., 21, pp. 758-760, (1995);
X. Bao, D. J. Webb, D. A. Jackson, “32-km Distributed temperature sensor using Brillouin loss in optical fibre”, Optics Lett., Vol. 18, No. 7, pp. 1561-1563, (1993);
Maughan S M, Kee H H, Newson T P, “57-km single-ended spontaneous Brillouin-based distributed fiber temperature sensor using microwave coherent detection”, Optics Lett., Vol. 26 (6), pp. 331-333;
T. Horigushi, M. Tateda, “Optical-fiber-attenuation investigation using Brillouin scattering between a pulse and a continuous wave”, Optics Lett., Vol. 14, p. 408, (1989);
“Sensing tape for easy integration of optical fiber sensors in composite structures”, B. Glisic, D. Inaudi, 16^{th} International Conference on Optical Fiber Sensors, Nara, Japan, 136th-17 Oct. 2003; and
“Development and field test of deformation sensors for concrete embedding”, D. Inaudi, S. Vurpillot, N. Casanova, A. Osa-Wyser, SPIE, Smart Structures and materials, San Diego, USA (1996), Vol. 2721, p 139-148.

There is a need in these high temperature thermal recovery applications for DTS technology capable of operating and delivering high quality data under the aggressive hydrogen environment.

### SUMMARY OF THE INVENTION

In one aspect of the present invention, a distributed temperature sensing system includes an optical sensing waveguide. The optical sensing waveguide is a single mode waveguide having a substantially pure silica core and a large outer diameter. The system further includes an optical instrument optically connected to the optical sensing waveguide. The optical instrument is configured for providing an optical excitation signal along the optical sensing waveguide, and is also configured for receiving a return optical signal indicative of the temperature at one or more locations along the optical sensing waveguide.

In another aspect of the present invention, a method of measuring distributed temperature includes providing an optical sensing waveguide. The optical sensing waveguide is a single mode waveguide having a substantially pure silica core and a large outer diameter. An optical excitation signal is generated along the optical sensing waveguide. A return optical signal is received and is indicative of a temperature at one or more locations along the optical sensing waveguide. The above-mentioned temperature is calculated based on a Brillouin effect.

### BRIEF DESCRIPTION OF THE DRAWINGS

FIG. 1 is a cross-sectional, elevation view of a distributed temperature sensing system embodying the present invention.

FIG. 2 is a graph illustrating nm loss v. H2 pressure of various sensing fiber materials

FIG. 3 are cross-sectional views taken along the longitudinal directions of a conventional optical fiber and an optical fiber or waveguide of the distributed temperature sensing system in accordance with the present invention.

FIG. 4 is a cross-sectional view taken along the longitudinal direction of an outer steel tube and optical fiber disposed therein in accordance with the present invention.

FIG. 5 is a cross-sectional view taken along the longitudinal direction of an optical fiber having a low friction outer coating in accordance with the present invention.

FIG. 6 is a cross-sectional view taken along the longitudinal direction of an optical fiber having a low friction outer coating with glass spheres in accordance with another embodiment of the present invention.

FIG. 7 is a cross-sectional view taken along the longitudinal direction of an optical fiber having a low friction outer coating disposed within an inner composite braided yarn/Teflon tube and within an outer Teflon tube in accordance with a further embodiment of the present invention.

### DETAILED DESCRIPTION OF THE PREFERRED EMBODIMENT

The subject of this invention is to realize a high temperature DTS system capable of operating in an aggressive hydrogen environment by leveraging the hydrogen tolerance of Brillouin systems and addressing the strain sensitivity of Brillouin sensing fibers through novel fiber and cable designs that eliminate strain introduced deployment and operation of these sensors in a broad range of applications covering harsh environments including, but not limited to, oil and gas wells. In addition these fibers may include pure silica core waveguide designs to augment hydrogen performance of the Brillouin system.

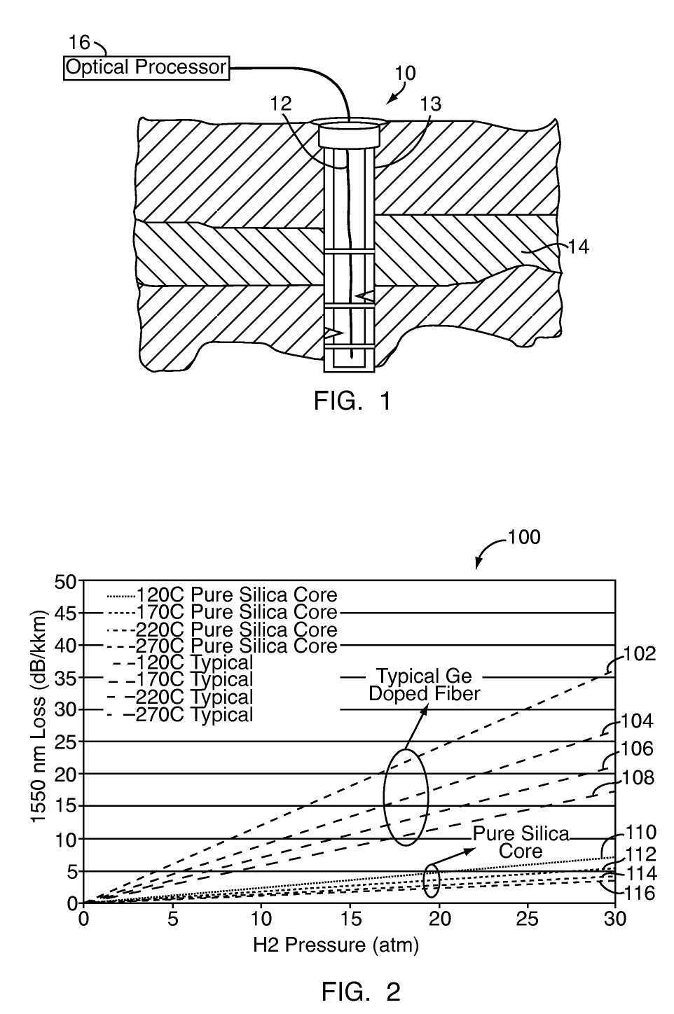

Referring to FIG. 1, a distributed temperature sensing system layout of one embodiment of the present disclosure is indicated generally by the reference number 10. The system 10 comprises a strain and hydrogen intolerant optical sensing cable or fiber waveguide 12 installed within an outer protective tube 13 into a harsh environment 14 and an optical instrument 16 (or readout box or optical processor or optical interrogation or the like) optically connected to the optical sensing cable or fiber to interrogate the optical response of the cable to temperature.

The optical instrument 16 is configured to provide the appropriate excitation (or incident) light and performs Brillouin Optical Time Domain Analysis (BOTDA) on the returning (or reflected) optical signal along the optical sensing fiber or waveguide 12. The optical instrument 16 may be any known optical instrument capable of performing BOTDA, e.g., a Fiber Optic Brillouin Analyzer, DiTeST, Model No. STA 200 Series, made by OmniSense, Riond Bosson 31110 Morges, Switzerland, www.omnisens.ch. In particular, the optical instrument 16 is optically connected to the sensing fiber 12 and injects pulses of incident light into the sensing fiber and analyzes the back reflected signal for temperature and strain induced frequency shifts. By measuring these shifts, the optical instrument 16 determines the state of strain and temperature along the length of the fiber 12, as is discussed in the paper, Daniele Inaudi and Branko Glisic, “Integration of distributed strain and temperature sensors in composite coiled tubing”, 2006 SPIE Smart Structures and Materials Conference, San Diego, Calif., Feb. 27 to Mar. 2, 2006, (Authors from SMARTEC SA, Via Pobiette 11, CH-6928 Manno, Switzerland, www.smartec.ch), which is incorporated herein by reference in its entirety.

FIG. 2 is a graph 100 illustrating optical signal loss (dB/km) v. H2 pressure in atmospheres for typical Ge doped fibers and pure silica core fibers at various temperatures. More specifically, line 102 illustrates the loss v. H2 pressure characteristic of a typical Ge doped fiber at 120° C.; line 104 illustrates the loss v. H2 pressure characteristic of a typical Ge doped fiber at 170° C.; line 106 illustrates the loss v. H2 pressure characteristic of a typical Ge doped fiber at 220° C.; line 108 illustrates the loss v. H2 pressure characteristic of a typical Ge doped fiber at 270° C.; line 110 illustrates the loss v. H2 pressure characteristic of a pure silica core fiber at 120° C.; line 112 illustrates the loss v. H2 pressure characteristic of a pure silica core fiber at 170° C.; line 114 illustrates the loss v. H2 pressure characteristic of a pure silica core fiber at 220° C.; line 116 illustrates the loss v. H2 pressure characteristic of a pure silica core fiber at 270° C.

In some embodiments, the core of the sensing fiber 12 may be made of a substantially pure (or undoped) silica core. A pure silica core fiber provides substantial insensitivity to hydrogen ingress. In particular, the absorption of light in the core of the fiber owing to hydrogen ingress is greatly increased with the presence of dopants such as GeO₂ and P₂O₅ in standard optical fibers. However, pure silica core fiber is designed and fabricated in a way to almost completely eliminate reaction sites for the hydrogen and thus eliminate the substantial permanent losses as shown in the graph of FIG. 2. The source of the optical signal loss is attributed to both “reversible” losses which occur because of the light absorption of free hydrogen which has diffused into the core and “irreversible losses” because of light absorption from hydrogen which has chemically reacted with the glass components. The “reversible” losses can be relatively minor, governed by the solubility of hydrogen in the glass which decreases with increasing temperature. However permanent losses are significantly larger in doped fibers as seen in FIG. 2—about four to five times greater than the reversible losses which can have a major impact on system performance.

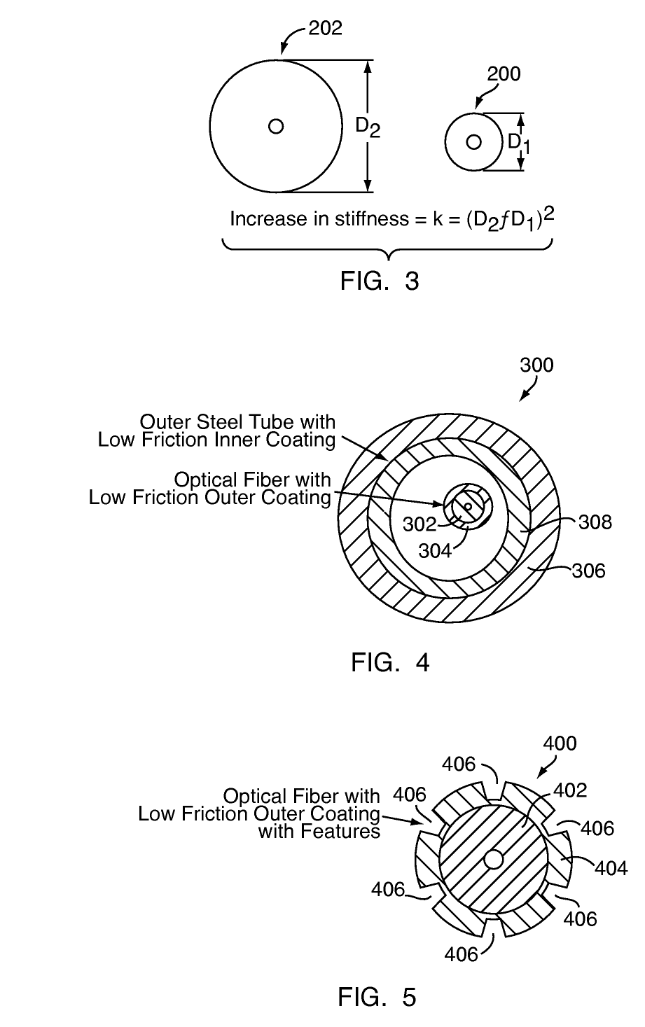

Referring to FIG. 3, the present invention minimizes the temperature measurement error caused by strain in the cable. In particular, the present invention minimizes the strain contribution to the frequency shift and hence is able to make a substantially strain insensitive temperature measurement. Conventional BOTDA systems may use 125 um diameter glass optical fiber, which may be packaged inside an outer protective tube such as, for example, a stainless steel tube. The stainless steel tube serves as a barrier to fluids and is typically 1 m inner diameter and larger to accommodate extra fibers, gels, and other materials. The outer diameter ranges from 2 mm and larger with wall thickness 1 mm and larger to allow for crush resistance during handling, installation, and hydrostatic pressure. In all of these various constructions the frictional forces at the interface between the fiber and the inside wall of the stainless steel tube may cause the fiber to be stretched along with the thermal expansion of the steel tube. This stretching produces strain in the sensing fiber affecting the accuracy of the temperature measurement.

Referring again to FIG. 3, a conventional optical sensing fiber 200 having a diameter D₁, and an optical sensing fiber or waveguide 202 having a diameter D₂ in accordance with the present invention are illustrated. The optical sensing fiber 202 embodying the present invention is a large diameter fiber (or waveguide), e.g., preferably about 250 um to about 1000 um diameter D₂, to produce a substantially stiffer structure as compared to the conventional optical sensing fiber 200 having a relatively smaller diameter D₁. The increase in stiffness can be determined by the equation k=(D₂/D )². The outer diameter D₂ of the sensing waveguide 202 may be any diameter greater than 125 microns that reduces the strain on the core along the length of the waveguide where the measurements are being taken or where the strain is the greatest. Further, the outer diameter D₂ may vary along its length depending on where the strain relief is needed. Also, the diameter of the core (center circle) of the sensing waveguide 202 is the same as that for a standard single mode optical fiber, e.g., 6 to 10 microns. In addition, a low friction inner tubing coating, such as Teflon, or any other material which has a coefficient of friction of about three to about four times less than that of the tube material, e.g., steel, allows the sensing fiber 202 to substantially “float” inside of the tube with applied strain only owing to gravity. This helps to minimize strain acting on the fiber 202 during thermal expansion of the steel tube.

FIG. 4 illustrates another embodiment of this “floater” concept. A distributed temperature sensing system indicated generally by the reference number 300 includes an optical sensing fiber or waveguide 302 having a large outer diameter in accordance with the present invention. The optical sensing fiber 302 is substantially surrounded by a low friction outer coating 304 such as Teflon. The optical sensing fiber 302 is disposed within an outer protective tube 306 such as, for example, a stainless steel tube. The tube 306 has a low friction inner coating 308 such as, for example, Teflon on its inner wall. The combination of the low friction inner coating 308 on the inner wall of the stainless steel tube 306 and the low friction outer coating 304 substantially surrounding the optical sensing fiber 302 retards any dragging or pulling of the optical sensing fiber during thermal expansion of the stainless steel tube.

With reference to FIG. 5, an optical sensing fiber or waveguide for a distributed temperature sensing system in accordance with another embodiment of the present invention is indicated generally by the reference number 400. An optical sensing fiber or waveguide 402 has a low friction outer coating 404. The isolation of movement of the optical sensing fiber 402 along with an opposing stainless steel outer tube (not shown) can be augmented with features in the low friction outer coating 404 such as slots or channels 406 defined in the coating to further reduce frictional forces. The slots or channels 406 are preferably arranged circumferentially about and extend in a longitudinal direction along the optical sensing fiber 402. The slots or channels 406 reduce the area of contact and thereby reduce friction between the optical sensing fiber 402 and the outer tube. The optical sensing fiber 402 with such low friction coating can be used in a stainless steel tube with or without a low friction inner coating.

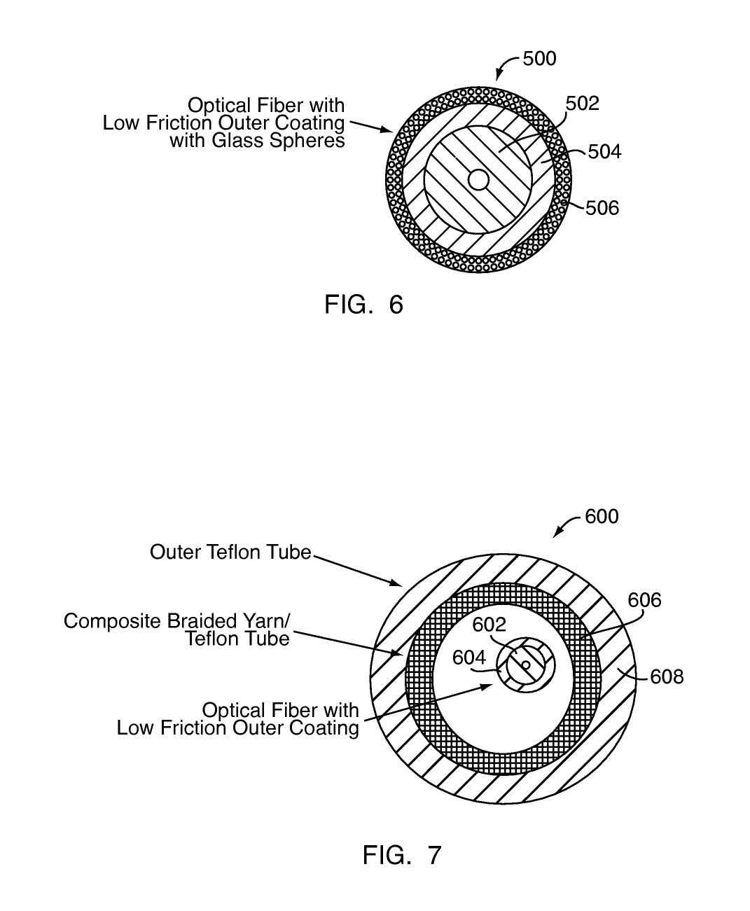

With reference to FIG. 6, an optical sensing fiber or waveguide for a distributed temperature sensing system in accordance with another embodiment of the present invention is indicated generally by the reference number 500. An optical sensing fiber or waveguide 502 has a low friction outer coating 504 and glass spheres 506 for reducing friction between the optical sensing fiber 502 and an opposing stainless steel outer tube (not shown). The isolation of movement of the optical sensing fiber 502 along with the stainless steel outer tube is augmented with additives in the low friction outer coating 504 that are especially effective against the stainless steel tube such as, for example, the glass spheres 506 embedded in the low friction outer coating. The low friction outer coating 504 can be, for example, a Teflon fiber coating. The low friction outer coating 504 with the glass spheres 506 is used within a stainless steel tube with a smooth or polished inner surface condition. Use of glass spheres in polymer coatings are currently used in so-called air-blown fibers that are routed through dedicated hard polymer tubings using air or other fluids to convey the fiber. In addition to low friction, the glass sphere outer surface lowers the surface contact between the fiber and tube.

With reference to FIG. 7, a distributed temperature sensing system in accordance with another embodiment of the present invention is indicated generally by the reference number 600. The system 600 includes an optical sensing fiber or waveguide 602 having a low friction outer coating 604. The optical sensing fiber 602 is disposed within a composite braided yarn/Teflon tube 606 having an outer Teflon region 608.

While the previous embodiments employing a low friction optical sensing fiber coating are effective in isolating strain acting on the optical sensing fiber by retarding the dragging forces as a result of thermal expansion of the outer stainless steel tube, the system 600 shown in FIG. 7. minimizes the dragging force by placing the optical sensing fiber 602 within a tube with a matched or closely matched thermal expansion rate. An outer tube of this type can be made by high temperature glass or ceramic yarn woven or braided into a tube 606, nominally 1-2 mm using similar methods in conventional braided Kevlar or similar cable construction. The braided glass/ceramic tube 606 is overjacketed with a Teflon extrusion process such that the Teflon permeates into the interstices of the braid to form a Braided Yarn/Teflon composite tube 606, with outer Teflon region 608.

In this structure, the fiber and protective tubing expand in unison, with the outer tube deflecting any external forces acting on the outer tube to mechanically isolate the fiber. If the outer Teflon tube is unable to overcome any dragging forces or unable to expand freely within its environment, the low friction polymer coated fiber will be free to move or “float” within the composite tube. This construction is especially useful and effective when used in a so-called coiled-tubing—a preferred method of installing and operating instrumentation in SAGD wells. A coiled tubing is a continuous length of ductile steel or composite tubing stored and transported in a coil on a large reel used to perform well intervention services such as well cleaning and pumping, fracturing, and completion workovers. It is uncoiled and pushed into the well using a coiled tubing injection rig. Tubing sizes range from 1 inch to 4½ inches; the larger the diameter, the farther it can be used. Typical SAGD coiled tubing instrumentation sizes are between 1″ and 2″. Instrumentation such as thermocouple cables and fiber optics are integrated within the coiled tubing and then the coiled tubing is injected into the well. Upon heating, the steel coiled tubing will expand and measures are taken by the installer to avoid compression or buckling of the expanded coiled tubing assembly. The construction shown in FIG. 7 is of size and stiffness to “float” within a typical 1″ or larger coiled tubing, and is able to resist the dragging force of the expanding coiled tubing. Any forces acting on the outer composite will be isolated from the fiber as it will float within this tube.

Although the present invention has been described herein using exemplary techniques, algorithms, and/or processes for implementing the present invention, it should be understood by those skilled in the art that other techniques, algorithms and processes or other combinations and sequences of the techniques, algorithms and processes described herein may be used or performed that achieve the same function(s) and/or result(s) described herein and which are included within the scope of the present invention.

It should be understood that, unless otherwise explicitly or implicitly indicated herein, any of the features, characteristics, alternatives or modifications described regarding a particular embodiment herein may also be applied, used, or incorporated with any other embodiment described herein. Also, the drawings herein are not drawn to scale.

Conditional language, such as, among others, “can,” “could,” “might,” or “may,” unless specifically stated otherwise, or otherwise understood within the context as used, is generally intended to convey that certain embodiments could include, but do not require, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described and illustrated with respect to exemplary embodiments thereof, the foregoing and various other additions and omissions may be made therein and thereto without departing from the spirit and scope of the present invention.

What is claimed is:

1. A distributed temperature sensing system comprising:
an optical sensing waveguide, the optical sensing waveguide being a single mode waveguide having a substantially pure silica core and a large outer diameter; and
an optical instrument optically connected to the optical sensing waveguide, the optical instrument being configured for providing an optical excitation signal along the optical sensing waveguide, and being configured for receiving a return optical signal indicative of the temperature at one or more locations along the optical sensing waveguide.

2. The system as defined in claim 1, wherein the large outer diameter is greater than about 250 microns.

3. The system as defined in claim 1, wherein the large outer diameter is about 250 microns to about 1000 microns.

4. The system as defined in claim 1, wherein the return optical signal is indicative of temperature based on a Brillouin effect.

5. The system as defined in claim 1, wherein the optical instrument is configured to perform Brillouin optical time domain analysis (BOTDA) on a returning or reflected optical signal along the optical sensing waveguide.

6. The system as defined in claim 1, wherein the optical instrument is configured to inject pulses of incident light into the optical sensing waveguide and analyze the back reflected light for temperature and strain induced frequency shifts to determine the state of strain and temperature along the length of the optical sensing waveguide.

7. The system as defined in claim 1, wherein a core of the optical sensing waveguide has a diameter of about six to about ten microns.

8. The system as defined in claim 1, further comprising an outer tube for accommodating the optical sensing waveguide therein, and wherein the tube has a low friction inner surface.

9. The system as defined in claim 1, further comprising an outer tube for accommodating the optical sensing waveguide therein, and wherein the tube has a low friction coating on an inner surface.

10. The system as defined in claim 9, wherein the low friction coating includes Teflon.

11. The system as defined in claim 9, wherein the low friction coating is a material having a coefficient of friction of about three to about four times less than that of a material of the tube.

12. The system as defined in claim 9, wherein the low friction coating is a material having a coefficient of friction of about three to about four times less than that of stainless steel.

13. The system as defined in claim 1, wherein the optical sensing waveguide has a low friction outer surface.

14. The system as defined in claim 1, wherein the optical sensing waveguide has a low friction outer coating.

15. The system as defined in claim 14, wherein the low friction outer coating includes Teflon.

16. The system as defined in claim 14, wherein the low friction outer coating defines slots or channels arranged circumferentially about and extending in a longitudinal direction along the optical sensing waveguide.

17. The system as defined in claim 14, wherein the low friction outer coating includes glass spheres imbedded therein.

18. The system as defined in claim 1, further comprising an outer tube for accommodating the optical sensing waveguide therein, the outer tube including a composite braided yarn/low friction coating.

19. The system as defined in claim 1, further comprising an outer tube for accommodating the optical sensing waveguide therein, the outer tube including a composite braided yarn/Teflon material having an outer Teflon region.

20. The system as defined in claim 18, wherein the braided yarn includes a high temperature glass or ceramic yarn.

21. A method of measuring distributed temperature comprising the steps of:
providing an optical sensing waveguide, the optical sensing waveguide being a single mode waveguide having a substantially pure silica core and a large outer diameter;
generating an optical excitation signal along the optical sensing waveguide;
receiving a return optical signal indicative of a temperature at one or more locations along the optical sensing waveguide; and
calculating said temperature based on a Brillouin effect.

22. The method as defined in claim 21, wherein the large outer diameter is greater than about 250 microns.

23. The method as defined in claim 21, wherein the large outer diameter is about 250 microns to about 1000 microns.

24. The method as defined in claim 21, further comprising the step of substantially enclosing the optical sensing waveguide within a tube having a low friction inner surface.

25. The method as defined in claim 21, wherein the step of calculating includes performing Brillouin optical time domain analysis (BOTDA) on the return optical signal along the optical sensing waveguide.

26. The method as defined in claim 21, wherein the step of generating includes injecting pulses of incident light into the optical sensing waveguide, and wherein the step of calculating includes analyzing the return optical signal for temperature and strain induced frequency shifts to determine the state of strain and temperature along the length of the optical sensing waveguide.
